(19) United States
(12) Patent Application Publication
(10) Pub. No.: US 2018/0181381 A1
(43) Pub. Date: Jun. 28, 2018

(54) APPLICATION PROGRAM PACKAGE PRE-INSTALLATION USER INTERFACE

(71) Applicant: Microsoft Technology Licensing, LLC, Redmond, WA (US)

(72) Inventors: Ran MICHAELY, Redmond, WA (US); Chaitanya Krishna DONTHINI, Bellevue, WA (US); James PIKE, Sammamish, WA (US); Arghyadip PAUL, Kirkland, WA (US)

(21) Appl. No.: 15/390,093

(22) Filed: Dec. 23, 2016

(51) Int. Cl. G06F 9/445; G06F 3/0484

(52) U.S. Cl. CPC G06F 8/61; G06F 3/04842

(57) ABSTRACT

Methods and devices for presenting application program information may include receiving an indication corresponding to a selection of a first user interface element associated with an application program package that includes a set of package information. Moreover, the methods and devices may retrieve a subset of package information from the set of package information by executing one or more packaging application program interfaces (APIs) to extract the subset of package information from the set of package information. The methods and devices may further display, within a user interface of the display, an application installation request window that includes the subset of package information

### BACKGROUND

The present disclosure relates to user interfaces of electronic devices, and more particularly, to providing an application program package pre-installation user interface at an electronic device.

A continually increasing number of software applications are being made available for use on computing and/or mobile devices. In some instances, before a user can use a software application, the software application may first be installed and configured on the computing device. A typical software application installation may involve a transfer of the files that comprise the software application onto the computing device, and the configuration of the software application and various components of the computing device to recognize and interact with each other. For example, the configuration of the computing device may include the addition or modification of registry settings, the configuration of one or more device drivers, and/or the configuration of operating system settings.

Further, a conventional installation program may be used to install the software application, which may first be saved locally at the computing device. Nonetheless, the conventional installation program may not provide any software application information to the user prior to installation. As such, a user may unknowingly install an incorrect or unintended software application. Moreover, the installation program may have a predefined set of user interfaces or pages that are presented to a user during the installation process. The predefined set of pages may not, however, cover all installation scenarios that may arise during the installation of a software application.

Thus, there is a need in the art for improvements in application program package installation.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its purpose is to present some concepts of one or more implementations in a simplified form as a prelude to the more detailed description that is presented later.

In one example, a method of presenting application program information on a display of an electronic device may include receiving an indication corresponding to a selection of a first user interface element associated with an application program package that includes a set of package information. The method may further include retrieving a subset of package information from the set of package information by executing one or more packaging application program interfaces (APIs) to extract the subset of package information from the set of package information. Additionally, the method may include displaying, within a user interface of the display, an application installation request window that includes the subset of package information.

In another example, an electronic device for presenting application program information comprising a memory configured to store data and instructions, a display configured to present information and a processor in communication with the memory and the display. The processor may be configured to receive an indication corresponding to a selection of a first user interface element associated with an application program package that includes a set of package information. The processor may further be configured to retrieve a subset of package information from the set of package information by executing one or more packaging application program interfaces (APIs) to extract the subset of package information from the set of package information. Additionally, the processor may be configured to display, within a user interface of the display, an application installation request window that includes the subset of package information.

In a further example, a computer-readable medium storing instructions executable by an electronic device for presenting application program information. The computer-readable medium may include at least one instruction for causing the computer device to receive an indication corresponding to a selection of a first user interface element associated with an application program package that includes a set of package information. The computer-readable medium may further include at least one instruction for causing the computer device to retrieve a subset of package information from the set of package information by executing one or more packaging application program interfaces (APIs) to extract the subset of package information from the set of package information. Additionally, the computer-readable medium may include at least one instruction for causing the computer device to display, within a user interface of a display, an application installation request window that includes the subset of package information.

Additional advantages and novel features relating to implementations of the present disclosure will be set forth in part in the description that follows, and in part will become more apparent to those skilled in the art upon examination of the following or upon learning by practice thereof.

### DESCRIPTION OF THE FIGURES

The specific features, implementations, and advantages of the disclosure will become better understood with regard to the following description, appended claims, and accompanying drawings where:

FIG. 1A is a schematic block diagram of an example electronic device including an application program installer in accordance with some implementations;

FIG. 1B is a schematic block diagram of the application program installer component and various subcomponents in accordance with some implementations;

FIGS. 2A-2I are conceptual diagrams of an application program installer user interface in various display states at an example electronic device in accordance with some implementations;

FIG. 3 is a chart diagram of an example application program package installation structure in accordance with some implementations;

FIGS. 4A and 4B are flow charts of an example of a method of presenting an application program package pre-install user interface in accordance with some implementations;

FIGS. 4C is a flow chart of an example of a method of acquiring a framework during an application program package pre-install procedure in accordance with some implementations; and

FIGS. 4D-4F are flow charts of another example of a method of presenting an application program package pre-install user interface in accordance with some implementations.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In some implementations, examples may be depicted with references to one or more components and one or more methods that may perform the actions or operations described herein, where components and/or actions/operations in dashed line may be optional.

The present disclosure relates to providing an application program package pre-install user interface at an electronic device. Currently, application programs may be installed on an electronic device without much information being provided to the user prior to, or during installation. Even more, the installation programs used to install such application programs may merely be an application program interface (API) (e.g., set of routines, protocols, and tools for building software applications) of or specific to a particular operating system that initiates an application program installation upon detecting a selection of a locally saved application program package at the electronic device. That is, such installation programs may not provide information related to the application program package in such a way so as to assist the user in determining whether to the install the application program package. Instead, the user may knowingly or unknowingly download an unintended application program package and initiate installation without any knowledge of the contents or details of the application program package prior to initiating installation. As such, it would be beneficial to extract such useful information from the application program package without downloading the entire package, and to present such useful information to the user prior to installation.

For instance, a user may search for a given application program using a search engine within a web browser. The user may locate the given application program for download at a webpage. The user may select a user interface element (e.g., hypertext link) triggering initiation of a download of the given application program. However, using the present implementations, rather than downloading the full application program upon selecting the user interface element, a subset of information may be extracted from the given application program and presented to the user without downloading the full application program. For example, to enable quick identification of the application program, the subset of information may include, but is not limited to, a title or name, a publisher, a version, application capabilities, and/or a logo of the application program. Based on the presentation of the subset of information, the user may make a more informed determination as to whether or not they wish to install the given application program on their computing or mobile device. As such, the present implementations provide a pre-installation user interface including a subset of application program package information presented to the user.

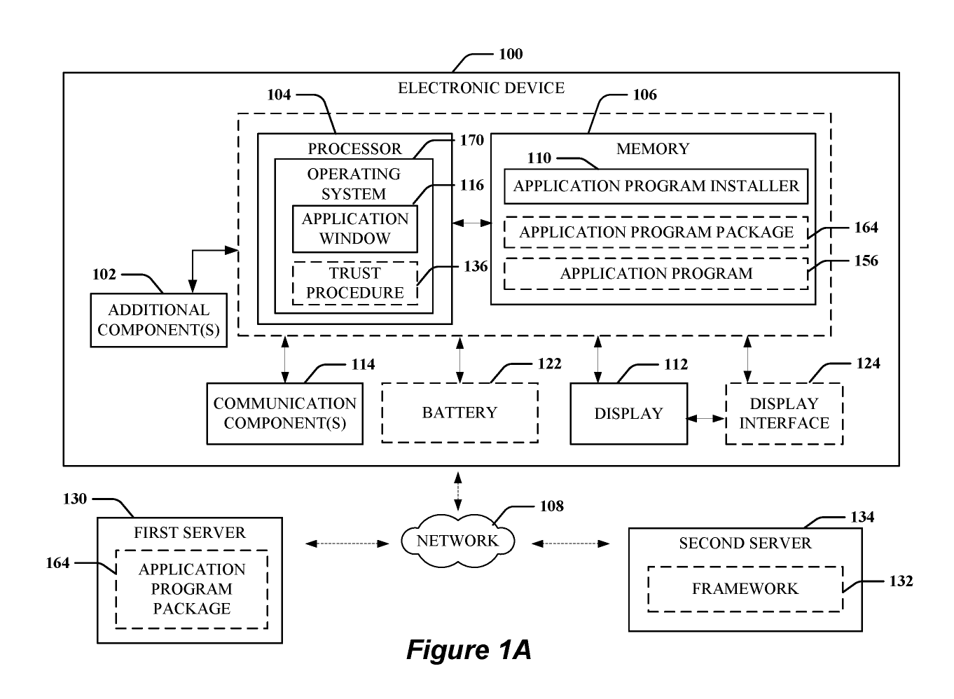

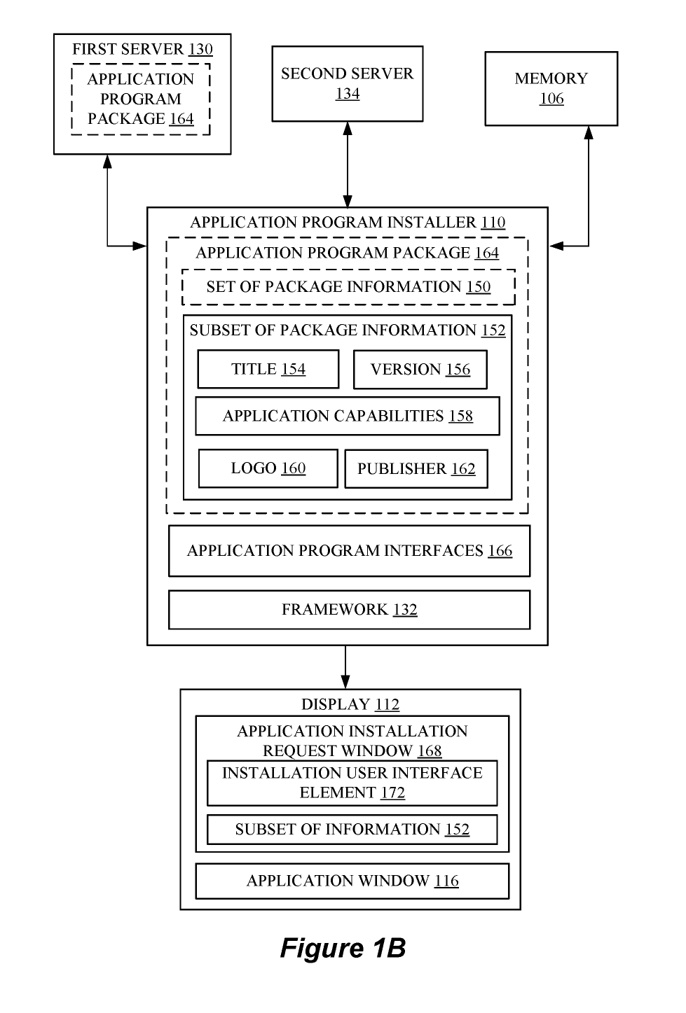

Referring now to FIGS. 1A and 1B, an example electronic device 100 may include one or more components and/or subcomponents such as an application program installer 110 for extracting a subset of package information 152 (FIG. 1B) from an application program package 164 stored at a first server 130 and used for downloading of an application program 156, such as a software application that may be run on electronic device 100. The subset of package information 152 may include information that describes characteristics of the application program 156 and/or the application program package 164. Further, application program installer 110 may be configured for providing the subset of package information 152 to a display 112 for presentation within an application installation request window 168 of a display 112. As such, the application program installer 110 enables a user of electronic device 100 to obtain information about the application program 156 and/or application program package 164 without having to download and install the entire application programming package 164.

In some implementations, the electronic device 100 may include or may otherwise be coupled with a processor 104 and/or a memory 106, where the processor 104 and/or the memory 106 may be configured to execute or store programs, instructions or other parameters, such as the application program installer 110, which may be an application including one or more APIs, application program package 164, which may be received from a first server 130, and/or an application program 156, which may be an installed application of the application program package 164. For example, the application program installer 110 may correspond to an operating system 170 of the electronic device 100 (e.g., a mobile operating system) or an application executing on the operating system 170 of the electronic device 100.

In some implementations, the electronic device 100 may also include a display 112 having a presentation area, such as a screen, for presenting one or more graphical interfaces (e.g., graphical user interfaces (GUI)), such as to provide information for consumption by a user of the electronic device 100. For example, the display 112 may be or may include a liquid crystal display (LCD), light emitting diode (LED), organic LED (OLED), high-contrast electronic ink (E-Ink), a fabric including light pipes, or a micro-LED array, and may display graphical interfaces as instructed by processor 104 (e.g., based on execution of the application program installer 110).

The electronic device 100 may also include display interface 124 that couples to display 112 to provide instructions, parameters, or signals, for example, for displaying the graphical interfaces. In some implementations, the display 112 and/or the display interface 124 may form a touch-sensitive display that may detect touch inputs on the display 112 (e.g., for interacting with a user interface) and also output data in the form of graphical representations (e.g., on the user interface). Further, display interface 124 may be a user interface component configured to receive inputs and further configured to generate outputs for presentation. Display interface 124 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, display interface 124 may include one or more output devices, including but not limited to a display, a speaker, a haptic feedback mechanism, a printer, any other mechanism capable of presenting an output to a user, or any combination thereof.

In some implementations, the electronic device 100 may also include one or more communication component(s) 114 (e.g., modems) for communicating with another device via a wired or wireless interface (Bluetooth, radio frequency identification (RFID), near field communication (NFC)). For example, the electronic device 100 may communicate with one or more devices via a network 108 (e.g., local area network, wireless network, Internet, and/or intranet). The electronic device 100 may also include a battery 122 for providing power to various components and/or subcomponents of the electronic device 100.

In addition, the electronic device 100 may include one or more additional components 102 for providing additional functionality to the electronic device 100. For example, the one or more additional components 102 may include but are not limited to a global positioning system (GPS) radio, a microphone, a memory, a processor, or a communication interface, such as an RFID radio, Bluetooth radio, or a Wi-Fi radio, one or more input devices (keyboard, mouse, etc.).

In some implementations, the electronic device 100 may include an operating system 170 executed by the processor 104 and/or the memory 106 of the electronic device 100. The memory 106 may be configured for storing data and/or computer-executable instructions defining and/or associated with the operating system 170 (and/or firmware), and the processor 104 may execute the operating system 170 and/or one or more associated components such as the application program installer 110. An example of the memory 106 can include, but is not limited to, a type of memory usable by a computer, such as random access memory (RAM), read only memory (ROM), tapes, magnetic discs, optical discs, volatile memory, non-volatile memory, and any combination thereof. An example of the processor 104 may include, but is not limited to, any processor specially programmed as described herein, including a controller, microcontroller, application specific integrated circuit (ASIC), field programmable gate array (FPGA), system on chip (SoC), or other programmable logic or state machine.

Referring more specifically to FIG. 1B, the application program installer 110 may at least extract information from the application program package 164 for presentation to a user on a display interface 124 of the display 112 and without downloading and installing the entire application program package 164 until an explicit instruction is received from the user. Specifically, the application program installer 110 may be an application program associated with one or more file types (e.g., extension based association) and including one or more APIs configured to extract information from the application program package 164 upon activation.

For example, the electronic device 100 may display, within display interface 124, an application window 116 associated with a particular (installed) application program providing access to an application program package 164 residing or stored at the first server 130. The first server 130 may be a third party server that stores and makes available one or more application program packages including the application program package 164. For example, the application window 116 associated with the particular application program 156 may include, but is not limited to, a web browser, an email application program, or a local application window of an operating system 170.

Within the application window 116, for instance, at least one user interface element may provide access to, or otherwise permit acquisition or downloading of the application program package 164 upon selection. For example, the user interface element displayed within the application window 116 may be at least one of a hypertext link within a web browser window corresponding to the application window 116, a selectable item/affordance referencing the application program 156 within an email message including the application program package 164, and/or an icon/affordance within a local drive window (e.g., application window 116) representing a location of the application program package 164. For example, a selectable item, icon, and/or affordance may be a user perceptible user interface element that, upon selection or interaction therewith, may trigger a subsequent action.

During presentation of the application window 116, which may request a user input in order to provide access to the application program package 164, the electronic device 100 may receive an indication corresponding to a selection of the user interface element corresponding to a download request user interface element referencing to the application program package 164. However, rather than immediately downloading to the entirety of the application program package 164 from the first server 130 and on to the memory 106 via network 108, the electronic device 100 may be configured to activate or launch the application program installer 110.

To activate or launch the application program installer 110 prior to a full downloading of the application program package 164, the application program installer 110 may be associated, via a file-type-association, with one or more application extension types. That is, in order to activate or launch the application program installer 110 without downloading the entirety of the application program package 164 upon detecting a selection of the user interface element, the operating system 170 may detect that the application program installer 110 is associated with certain file type extensions (e.g., .appx) and may launch the application program installer 110 accordingly. For example, the application program installer 110 may run or be triggered by selection of certain types of files or application programs, such as, but not limited to .appx packages.

The application program installer 110, once launched or activated, may extract, using one or more APIs 166, a subset of package information 152 from a set of package information 150 forming the application program package 164. The APIs 166 may interact with (e.g., identify, location, and/or obtain) the subset of package information 152 from the different parts of the set of package information 150 and modify it, if necessary, for presentation to the user. For example, the set of package information 150 may be an entire set of files and resources, some or all of which may be compressed, forming the application program package 164. Specifically, the application program installer 110 may forego downloading the entire application program package 164 corresponding to the set of package information 150 and instead may initially locate, extract, and download/acquire the subset of package information 152 to allow the user to obtain some details about the application program before it is completely downloaded. Suitable examples of the subset of package information 152 may include, but are not limited to, data representing a name or title 154, a version 156, application capabilities 158, a logo 160, and a publisher 162 of the application program package 164, or any other information that may be useful to a user in determining whether or not the download the application program package 164.

The title 154 may be a description of the name of the application program package (FIGS. 1A and 1B. The publisher 162 may be a publishing entity of the application program package (FIGS. 1A and 1B. The version may be a unique number or alphanumeric combination corresponding to a unique state of the application program package (FIGS. 1A and 1B). The application capabilities 158 may be a list of one or more features (Internet and public networks, media library, etc.) provided by the application program 156 (FIGS. 1A and 1B). Further, the logo 160 may be an image or graphic representing or corresponding to the application program package 164 (FIGS. 1A and 1B).

In an example, as the application program package 164 may be formed based on a standard file structure, and information such as, but not limited to, a block map file may be initially downloaded to identify and extract certain fields, or metadata (e.g., a set of data that describes and gives information about other data) that contains the subset of package information 152. Specifically, a block map file may be a representation of various portions of the application program package 164. The block map file may correspond to a block level representation of the files forming the application program package 164, where each block includes a hash value corresponding to an address identifier. As such, the subset of package information 152 may be located and extracted using the address identifier to obtain the desired blocks of information. In some implementations, the block map file may be part of the subset of package information 152.

For example, a header of the block map file may include one or more header fields that define operating parameters of the application program package 164. More specifically, the application program installer 110 may be configured to use the APIs 166 to read the application program package 164 metadata. For instance, a manifest file, which may include metadata for a group of accompanying files that are part of a set or coherent unit, may be accessed and/or acquired using or based on the header of the block map file. In particular, the application program installer 110 may locate and extract the subset of package information 152 using at least the manifest file, . The manifest file may include information such as, but not limited to, the application capabilities 158, an extension and framework 132, and the name or title 154 of the application program 156 , or any other ones of the subset of package information 152. In some implementations, the metadata (e.g., header and/or manifest file) and/or the subset of package information 152 may be stored or cached in a temporary file in memory 106.

Further, within the set of package information 150, the application program package 164 may include one or more language-specific subsets of information (e.g., a language-specific version of the subset of package information 152) associated with various languages or locales/regions (which may also be part of the metadata). The application program installer 110 may identify the language or locale of the electronic device 100 and acquire the subset of package information 152 for the language and/or locale. For example, the application program installer 110 may read or obtain a value representing the language and/or the locale (e.g., geographic location, country . . . ) stored in the memory 106 of the operating system 170 and acquire those resources corresponding to language or locale (e.g., the language-specific version of the subset of package information 152). If the title 154 of the application program 156 is different depending on which language or locale the application program package 164 is run or executed, then application program installer 110 may acquire or download the language or locale information. In other words, rather than downloading the entire application program package 164, based on identifying a language or locale setting for electronic device 100, application program installer 110 may only download a subset of information corresponding to the identified language or locale, thereby saving download overhead and/or local memory resources.

In the manifest file, the title 154 of the application program package 164 may not be explicitly listed. Instead, the title 154 may be a key word or variable within the manifest file that is not the title 154 that nonetheless links to the title 154. Depending on a value of the language or locale, the application program installer 110 may correlate the key word or variable to display the title 154 or any other portion of the set of package information 152 of the application program package 164 to user. In other words, the key word or variable may be language-specific, so that application program installer 110 may identify the language, and then identifies a language-specific key word or variable that matches the identified language.

In some implementations, referring back to FIG. 1A, the electronic device 100 may be configured to activate or execute a trust procedure 136 (e.g., a set of functions or interactions that may be define in HW, SW, or some combination thereof) prior to activation of the application program installer 110. The trust procedure 136 may determine whether a publisher 162 (FIG. 1B) of the application program package 164 is stored within a database of known or verified publishers and/or whether the application program package 164 is signed with a trusted certificate. For example, the trust procedure 136 may determine whether the publisher 162 has a corresponding reputation level, or in some implementations, the particular reputation level of the publisher 162 of the application program package 164. For example, the reputation level may be at least one of a known reputable application, a warning corresponding to an unverifiable reputation level, and/or an unknown publisher. If the publisher is determined not to have a reputation level, or if the reputation level is below a reputation threshold value, then the trust procedure 136 may present, on the display interface 124 of the display 112, a warning window informing the user that the publisher 162 is unknown and/or untrusted, along with presenting a user interface element for allowing the user to proceed with the installation and/or abort the installation.

The application program installer 110 may launch and initiate extraction of the subset of package information 152 after the user interface element is selected (e.g., detection of click on hypertext link), or after the trust procedure 136 is performed and the user elects to continue if a warning window is presented on display 112.

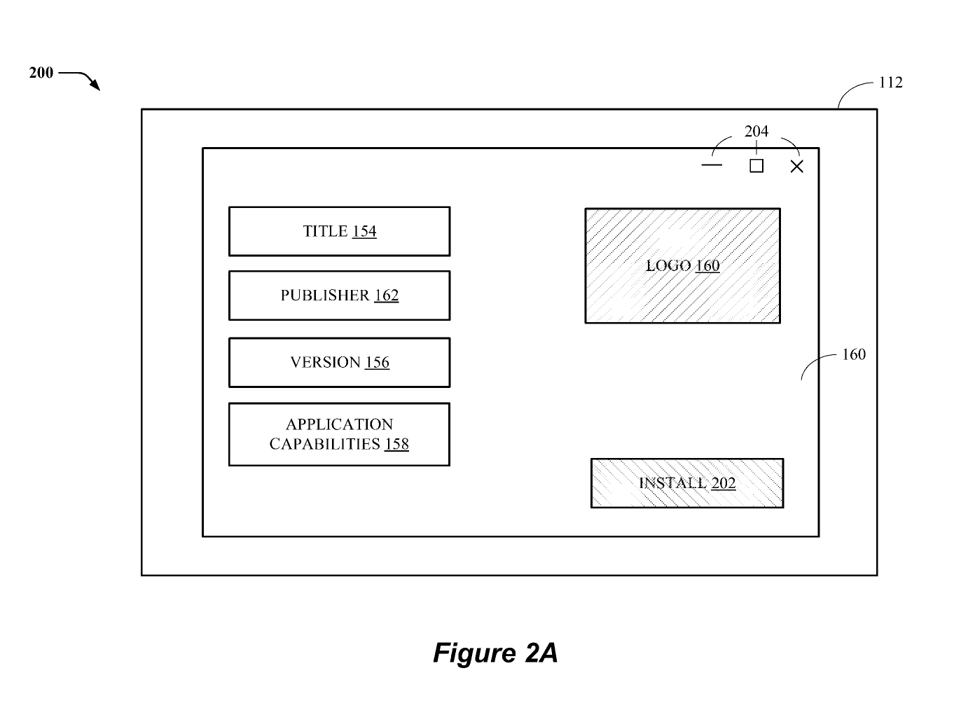

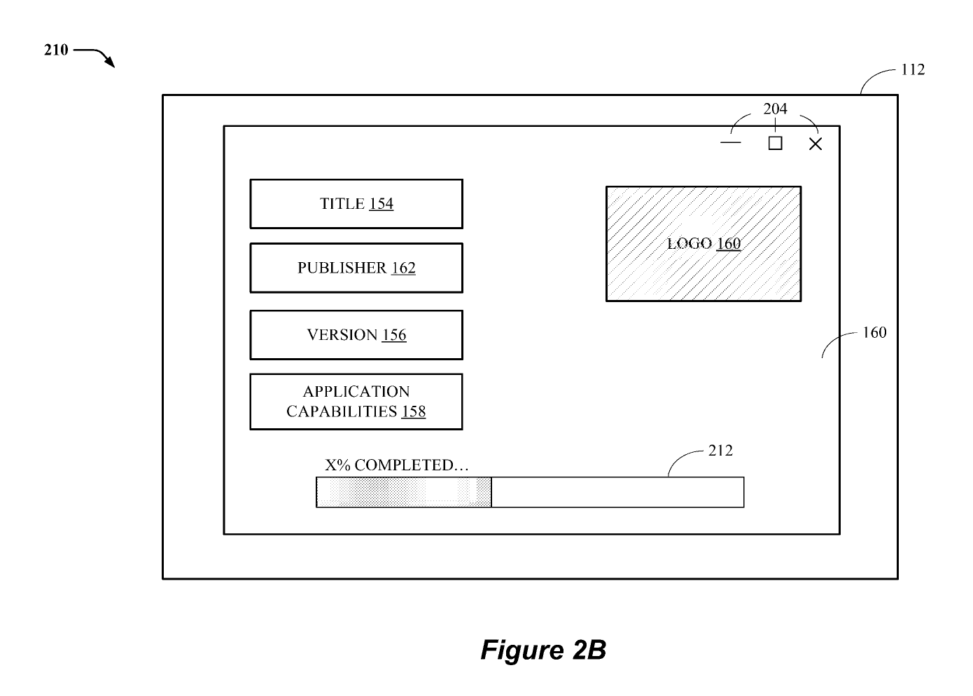

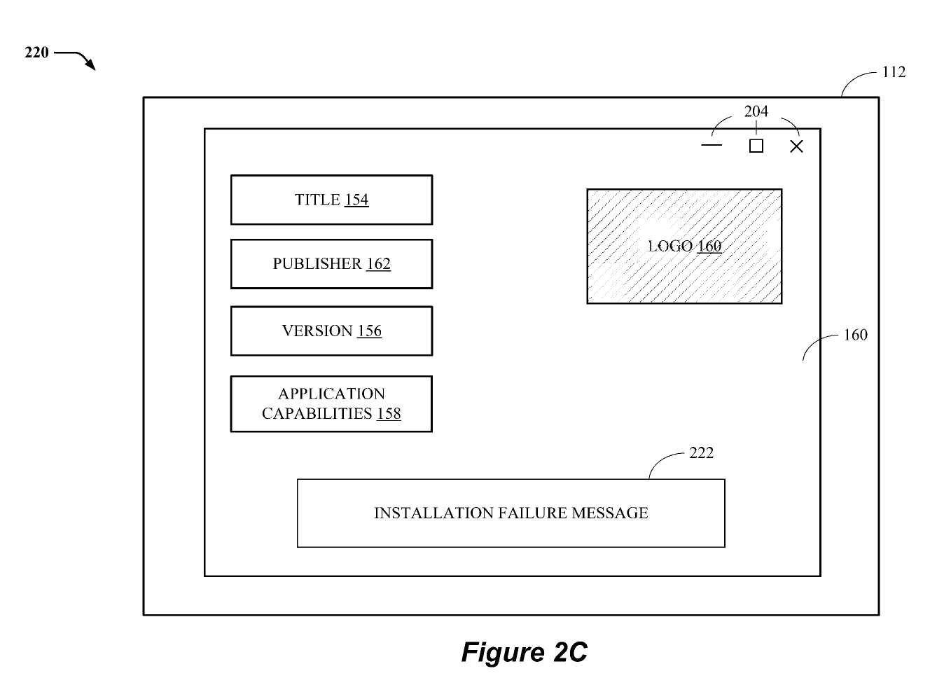

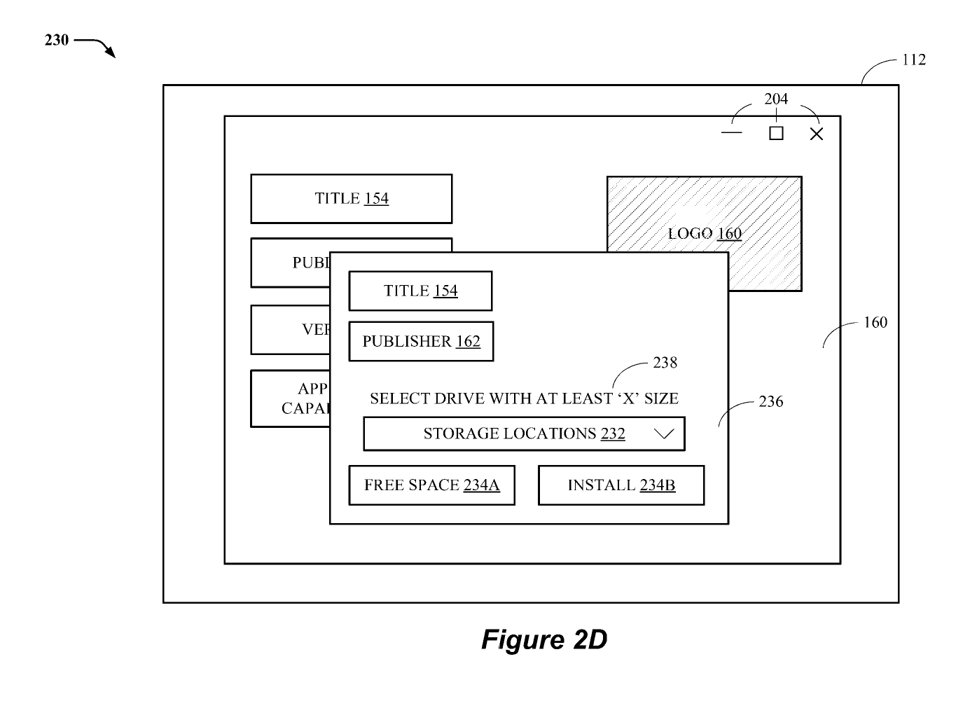

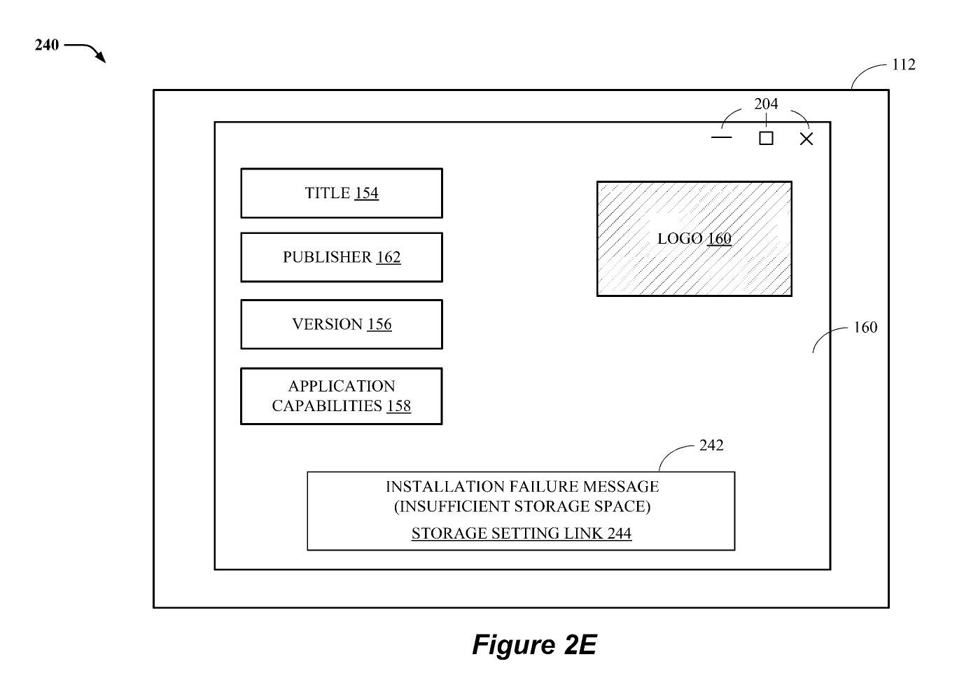

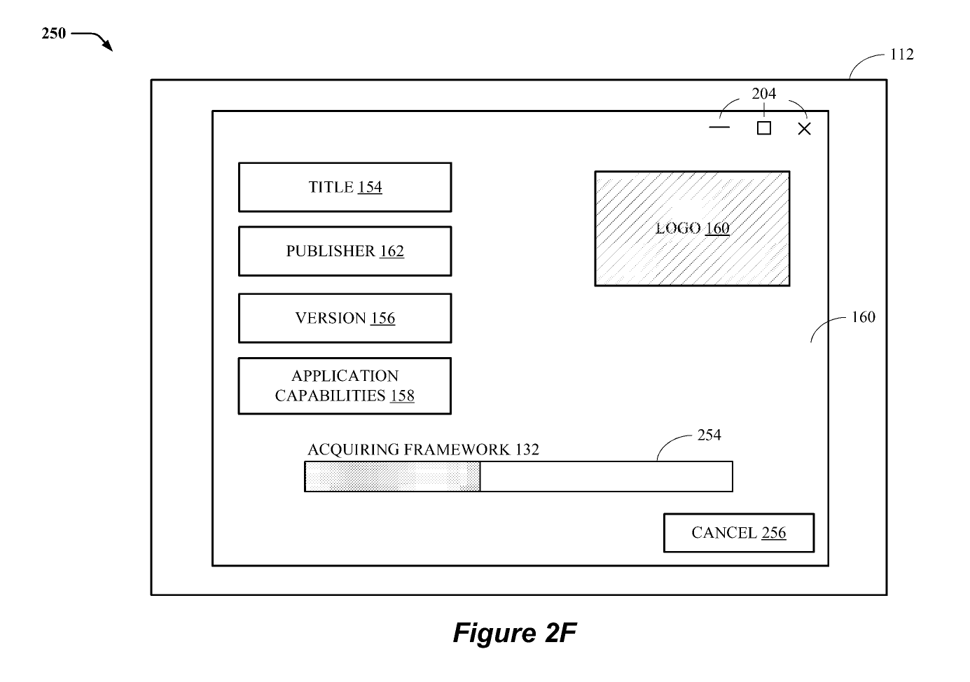

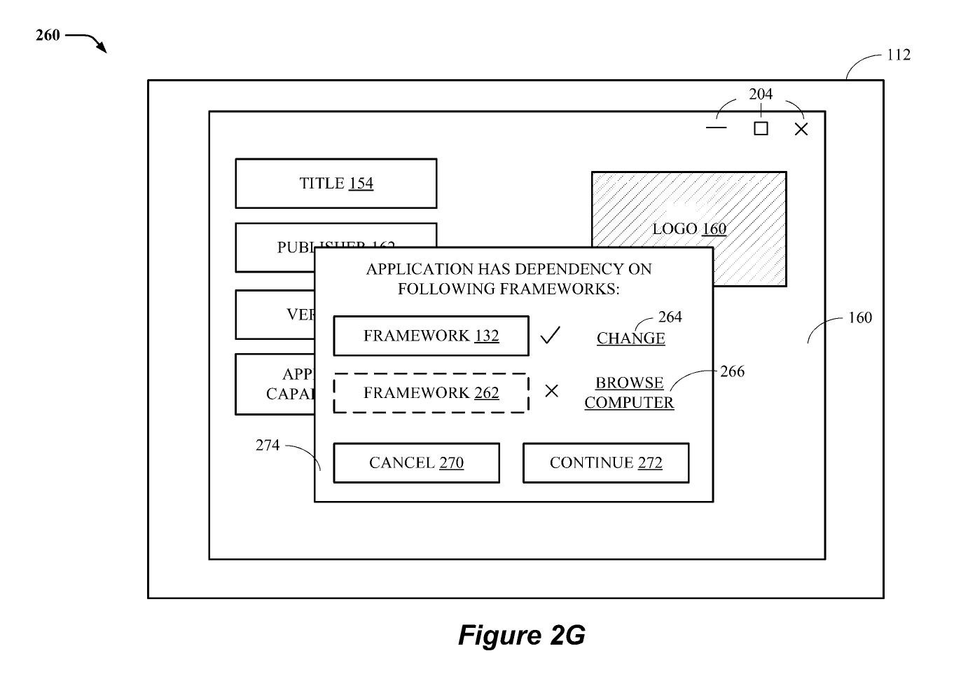

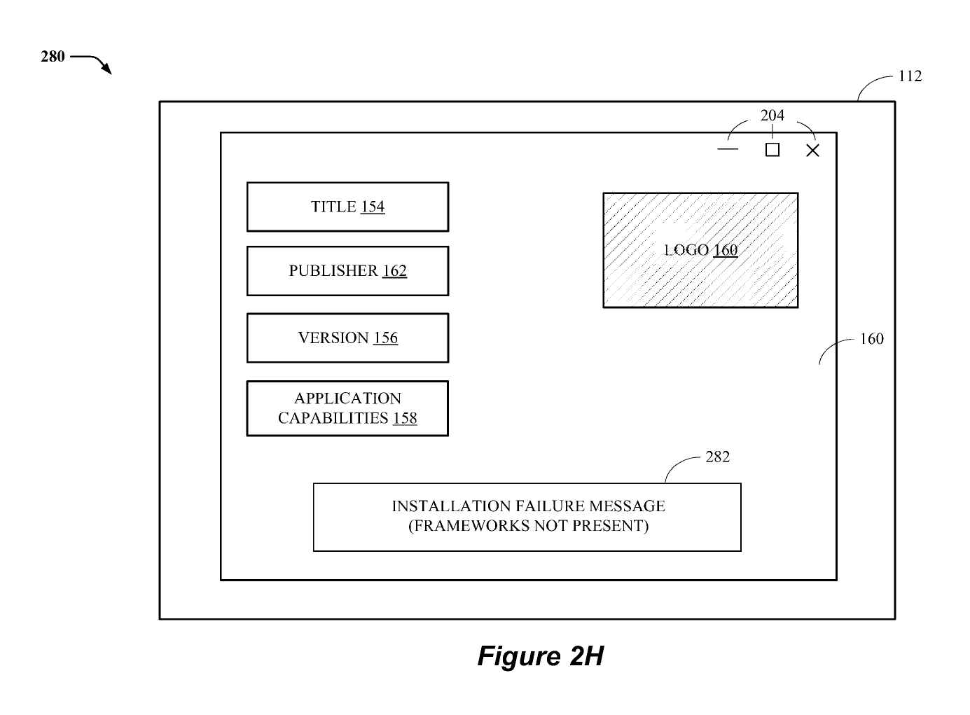

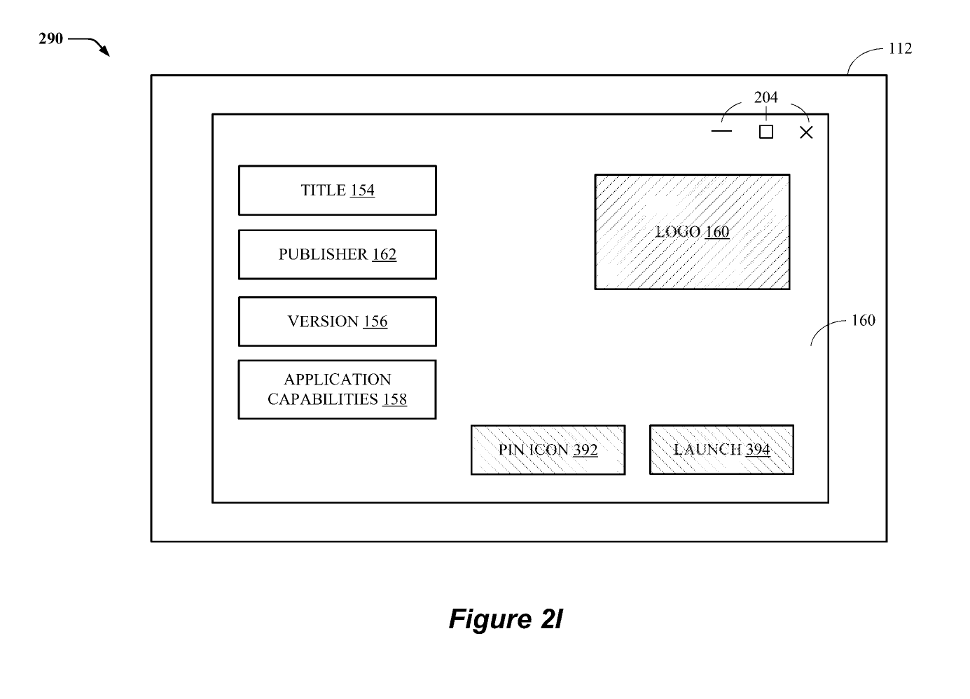

Upon extracting the subset of package information 152 from the application program package 164, which may include any combination of the title 154, the version 156, the application capabilities 158, the logo 160, and/or the publisher 162 of the application program 156, the application program installer 110 may provide the subset of package information 152 to the display 112 for presentation, within the display interface 124, such as via the application installation request window 168. Specifically, the application installation request window 168 may be a user interface presenting at least the subset of package information 152 and an installation user interface element 172 for selection to proceed with or otherwise trigger installation or to abort the installation. For instance, examples of the application installation request window 168 are illustrated and described herein with respect to FIGS. 2A-2I.

Installation of all or relevant portions of the application program package 164 may rely or be dependent upon at least one framework 132 associated with the operating system 170. A framework 132 may be a reusable software environment or interface that provides particular functionality as part of a larger platform (e.g., the operating system 170). If the electronic device 100 does not include the framework 132 that provides for operation of the application program 156 within the operating system 170, installation or operation of the application program 156 via the application program package 164 may fail.

To address such scenario, the application program installer 110 may also obtain the framework 132 (or frameworks) that provide functionality for the application program package 164. For example, upon detecting a selection of the installation user interface element 172 within the application installation request window 168, the application program installer 110 may check whether the framework 132 is present at the electronic device 100. In the event the framework 132 is not present or available at the electronic device 100, the application program installer 110 may retrieve and download, via the network 108, the framework 132 from the second server 134, which may be a first party (e.g., entity directly associated with the operation system 170 and/or application program package 164) or third party (e.g. entity not directly associated with the operating system 170 and/or application program package 164) server remote from the electronic device 100, in order to proceed with download of the set of package information 150 and installation of the application program package 164.

FIGS. 2A-2I are conceptual diagrams of application program installer 110 (FIGS. 1A and 1B) user interfaces at electronic device 100 (FIG. 1A) in accordance with some implementations. For example, the application program installer 110 (FIGS. 1A and 1B) user interfaces may be or otherwise correspond to the application installation request window 168 having various user interfaces and user interface elements for presenting at least the subset of package information 152 (FIG. 1B) to the user on the display 112 as part of the pre-installation procedure of the application program package 164 (FIGS. 1A and 1B). The application installation request window 168 having the various user interfaces may provide a user friendly experience that assists the user with effectively identifying and determining whether to install the application program package 164 (FIGS. 1A and 1B) prior to a full download of the application program package 164.

For instance, referring to FIG. 2A, a first user interface 200 may be displayed on display 112, and may include the application installation request window 168. The application installation request window 168 may include the subset of package information 152 (FIG. 1B) such as, the title 154, the publisher 162, the version 156, the application capabilities 158, and the logo 160 of the application program package 164 (FIGS. 1A and 1B). The application installation request window 168 may further include one or more window configurable user interface elements (e.g., buttons/affordances) 204, such as a minimize user interface element, a maximize user interface element, and/or an exit/close user interface element at a location on the application installation request window 168.

The application installation request window 168 may also include at least one user interface element corresponding to an install 202 button (e.g., may be similar to the installation user interface element 172, FIG. 1B). The install 202 button may permit the user to trigger downloading of the entire set of package information 150 (FIG. 1B) of the application program package 164 (FIGS. 1A and 1B) from the first server 130 (FIGS. 1A and 1B) and installation of the application program 156 (FIGS. 1A and 1B) at electronic device 100 (FIG. 1A).

Upon detecting a selection of the install 202 button, the application program installer 110 may provide information related to a progress of the download and installation via display 112. For example, referring to FIG. 2B, user interface 210 may include a progress bar 212 or other graphic or alphanumeric presentation representing a status (e.g., X % completed, where X is a number, for instance, having a value in a range of 0 to 100) of the level of completion of the download of the application program package 164 (FIGS. 1A and 1B) within the application installation request window 168. In some implementations, the progress bar 212 may represent one or both of the downloading of the set of package information 150 (FIG. 1B) and/or the installation of the application program 156 (FIG. 1A) from the application program package 164 (FIGS. 1A and 1B) (e.g., in the event the application program package 164 (FIGS. 1A and 1B) has been saved or stored locally at memory 106, FIG. 1A). In some implementations, the progress bar 212 may represent one or both of a staging (e.g., local file download procedure) and a registration of the application program package 164 (FIGS. 1A and 1B).

Further, referring to FIG. 2C, a user interface 220 may include an installation failure message 222 related to a status of the level of completion of the download of the application program package 164 (FIGS. 1A and 1B) following activation of the install 202 button. Specifically, the application installation request window 168 may present the installation failure message 222 in the event a failure occurs during installation of the application program package 164 (FIGS. 1A and 1B). For example, the installation failure message 222 may indicate that not all of the application program package 164 (or the relevant portions thereof, such as a language-specific subset thereof) were successfully downloaded (e.g., possibly due to a communication failure, lack of sufficient available memory, or for any other reason), or that a new certificate may be needed as part of installing the application program package 164 (FIGS. 1A and 1B), or that a new application program package 164 (FIGS. 1A and 1B) may be needed having a trusted certificate.

Moreover, referring to FIG. 2D, a user interface 230 may allow a user to select a storage location for download and/or installation of the application program package 164 (FIGS. 1A and 1B). For example, the electronic device 100 (FIG. 1A) may detect initiation of the downloading and query the user for a storage location, or may detect that downloading and/or installation the application program package 164 (FIGS. 1A and 1B) may exceed a storage capacity of a default or selected storage location or of the memory 106 (FIG. 1A). That is, the memory 106 (FIG. 1A) may not have enough storage space to accommodate the download and/or installation of the application program package 164 (FIGS. 1A and 1B). Accordingly, user interface 230 may provide, within the application installation request window 168, a sub-window 236 including at least the title 154, the publisher 162, a drop down list of storage locations 232 (e.g., locations within memory 106, locations within other data storage devices in communication with electronic device 100), and at least two user interface elements such as free space 234A button/affordance, which may permit the user, upon selection of a specific storage location, to free an amount of memory space and an install 234B button/affordance, which may permit the user to install the application program package 164 (FIGS. 1A and 1B) in a selected storage location from the list of storage locations 232. Further, for instance, required space indicator 238 may request a user select a drive with at least ‘X’ size, which may correspond to a minimum amount of memory space needed for the download and/or installation of the application program package 164 (FIGS. 1A and 1B).

Referring to FIG. 2E, in some instances, download and/or installation of the application program package 164 (FIGS. 1A and 1B) may result in a failure even after selection of a storage location in FIG. 2D. For instance, a user interface 240 may present the application installation request window 168 including an installation failure message 242 that may indicate that the installation of the application program package 164 (FIGS. 1A and 1B) failed due to insufficient storage space at the default or selected storage location and/or in the memory 106. The installation failure message 242 may also include a user interface element corresponding to a storage setting link 244 that, upon selection, displays the sub-window 236 from FIG. 2D.

Referring to FIG. 2F, a user interface 250 may display, within the application installation request window 168, a framework acquisition progress bar 254. For example, in some implementations, the application program installer 110 (FIGS. 1A and 1B) may be configured to detect or otherwise determine, upon a selection of the install 202 button in FIG. 2A, that the framework 132 used as part of the installation of the application program package 164 is not present or stored at the electronic device 100. Accordingly, the application program installer 110 may be configured to locate the framework 132 based on the extraction of the subset of package information 152 (e.g., metadata) and acquire the framework 132 from the second server 134 (FIG. 1A). As such, within the application installation request window 168, a framework acquisition progress bar 254 representing a status of a level of completion of downloading the framework 132 may be displayed along with a cancel 256 button that may be selected in the event the user desires to halt the acquisition of the framework 132 and terminate the installation of the application program package 164 (FIGS. 1A and 1B).

Referring to FIG. 2G, for local-based framework installation, a user interface 260 may include, within the application installation request window 168, a framework sub-window 274. For instance, within the framework sub-window 274, the application program installer 110 may permit a selection of a location of at least one framework used for installation of the application program package 164 (FIGS. 1A and 1B) based on a selection of a change 264 button or a browse computer 266 button, both of which may trigger a presentation of one or more local locations within electronic device 100 (FIG. 1A) that may include one or both of framework 132 or framework 262. The framework sub-window 274 may include a listing of the frameworks such as the framework 132 and framework 262, as well as an indication of whether the framework has been located at the memory 106.

The framework sub-window 274 also provides user interface elements that identify a location (e.g., a location in memory 106 of electronic device 100 for a framework currently residing on the electronic device 100, or a location or web address of a server on a network where the framework may be downloaded if not present on the electronic device 100). Further, the framework sub-window 274 may also include an ability to change where to obtain the frameworks, such as via a change 264 button and/or a browse computer 266 button, respectively. The framework sub-window may also include a cancel 270 button and a continue 272 button to terminate the installation procedure or proceed with the installation procedure, respectively.

Referring to FIG. 2H, in the event a framework used as part of the installation of the application program package 164 (FIGS. 1A and 1B) is not present or is not able to be obtained (see, e.g., FIG. 2G), an installation failure message 282 may be displayed as part of user interface 280.

Referring to FIG. 2I, a user interface 290 may include a number of user interface elements following completion of installation of (all or relevant portions of) the application program package 164 (FIGS. 1A and 1B). For example, the user interface 290 may include, within the application installation request window 168, a pin icon button 392 that allows, upon selection, for an icon of the installed application program 156 to be pinned to a user interface control element. such as a control bar, menu, or window. Further, the user interface 290 may include, within the application installation request window 168, a launch button 394 configured to, upon selection, launch or run the installed application program 156.

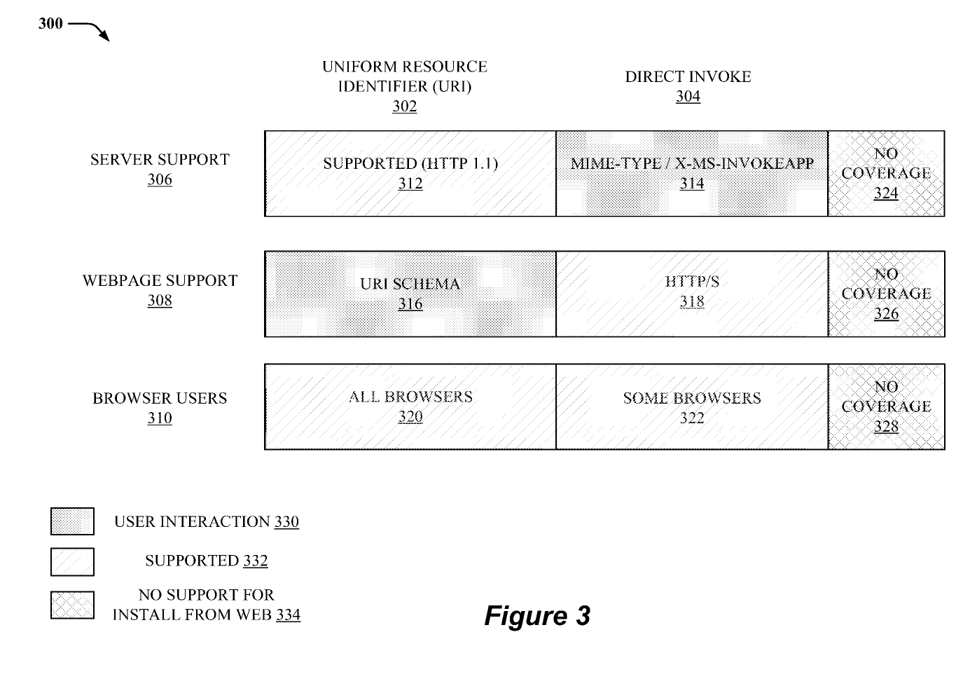

Referring now to FIG. 3, an example application program package installation structure 300 in accordance with some implementations identifies various approaches for extracting information from and/or installing the application program package 164 on the electronic device 100. For example, according to application program package installation structure 300, the application program installer 110 (FIGS. 1A and 1B) may support a direct invoke 304 approach, where the application program installer 110 (FIGS. 1A and 1B) may support some browsers 322 associated with the browser users 310. Further, server support 306 may be provided in the direct invoke 304 in the form of Multipurpose Internet Mail Extensions (MIME) type and/or an X-MS-InvokeApp.

Specifically, MIME types may describe a media type of content either in email or served by web servers or web applications and are intended to help guide a web browser in how the content is to be processed and displayed. An X-MS-InvokeApp may indicate that a server is requesting that the direct invoke 304 configured application be used. Further, a X-MS-InvokeApp hypertext transfer protocol (HTTP) response header may be used as part of the server support 306. As part of the webpage support 308, an HTTP or HTTP secure (HTTPS) uniform resource identifier (URI) may be utilized, where in some instance, an opt-in flag may be provided by the webpage. Post-processing the uniform resource identifier (URI) 302 may not be performed to be used by application program packaging and deployment APIs. A URI may be a location or address identifying where documents/files may be located on a network or the Internet.

For the URI 302 approach, all browsers 320 may be supported for the browser users 310 resulting in a browser independent approach. However, a webpage may be changed to refer to the application program package 164 (FIGS. 1A and 1B) by a configured URI schema 316 as part of the webpage support 308. The URI schema 316 may be registered as ‘ms-apppackage-http’ for an HTTP URI and ‘ms-apppackage-https’ for an HTTPS URI, for example. As such, the URI may be used instead of a default HTTP/S URI while referring to the application program package 164 (FIGS. 1A and 1B). The server support 306 may not be adjusted as HTTP support may be provided. Post-processing of the URI may be performed to be used by application program packaging and deployment APIs.

Each of server support 306, webpage support 308, and browser users 310 may also have, in some instances, no coverage 324, 326, and 328, respectively. In some implementations, the application program installer 110 (FIGS. 1A and 1B) may employ a combination of the URI 302 approach and the direct invoke 304 approach.

Further, the legend illustrated in FIG. 3 provides for a user interaction 330 in a first pattern, a supported scheme/approach 332 in a second pattern, and no support for install from web 334 in a third pattern, each of which may be associated with a respective one of the server support 306, the webpage support 308, and the browser users support 310.

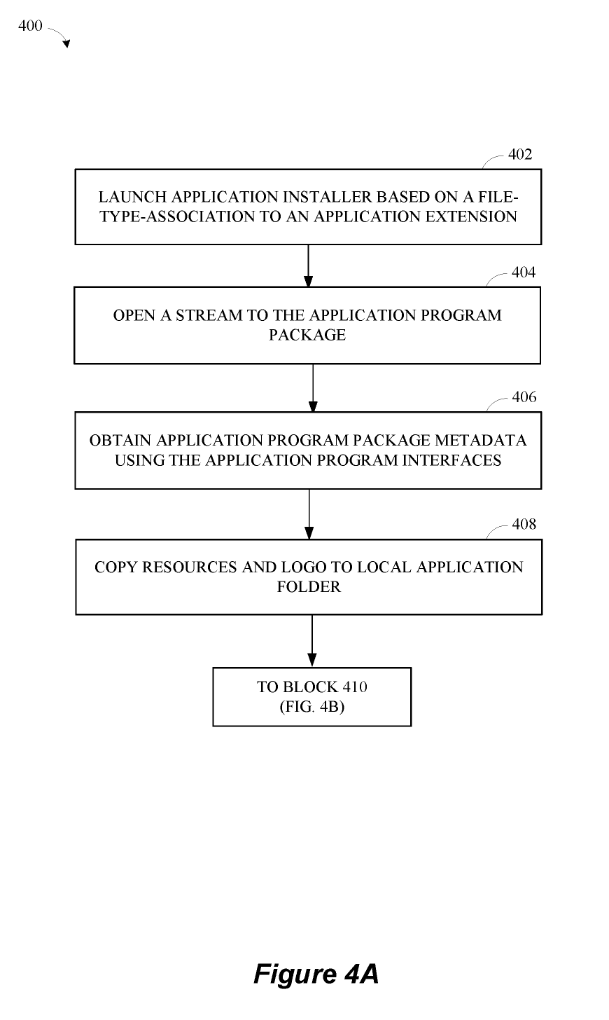

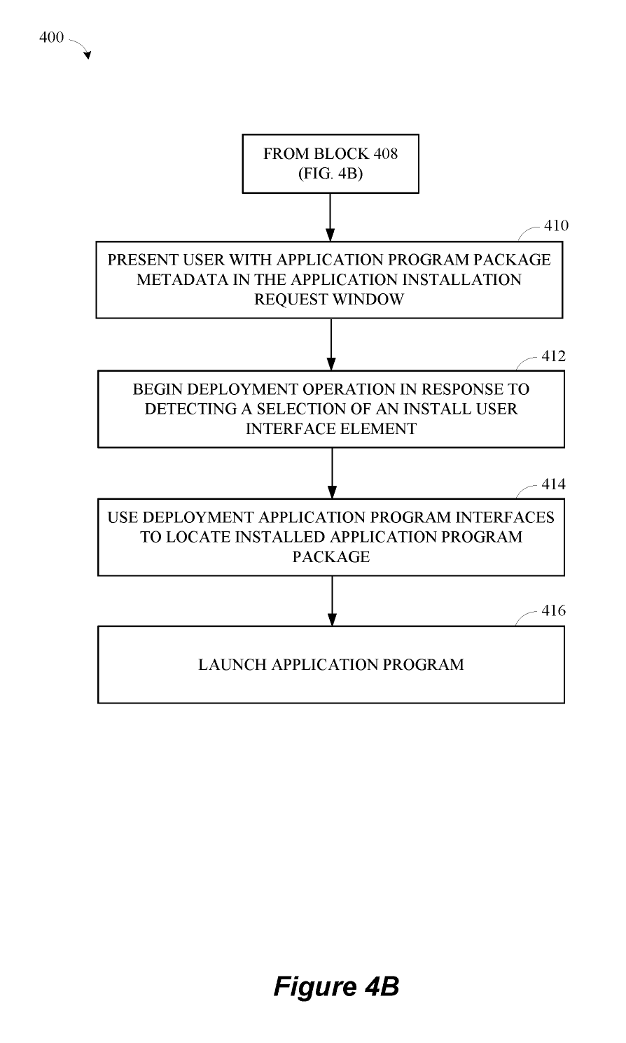

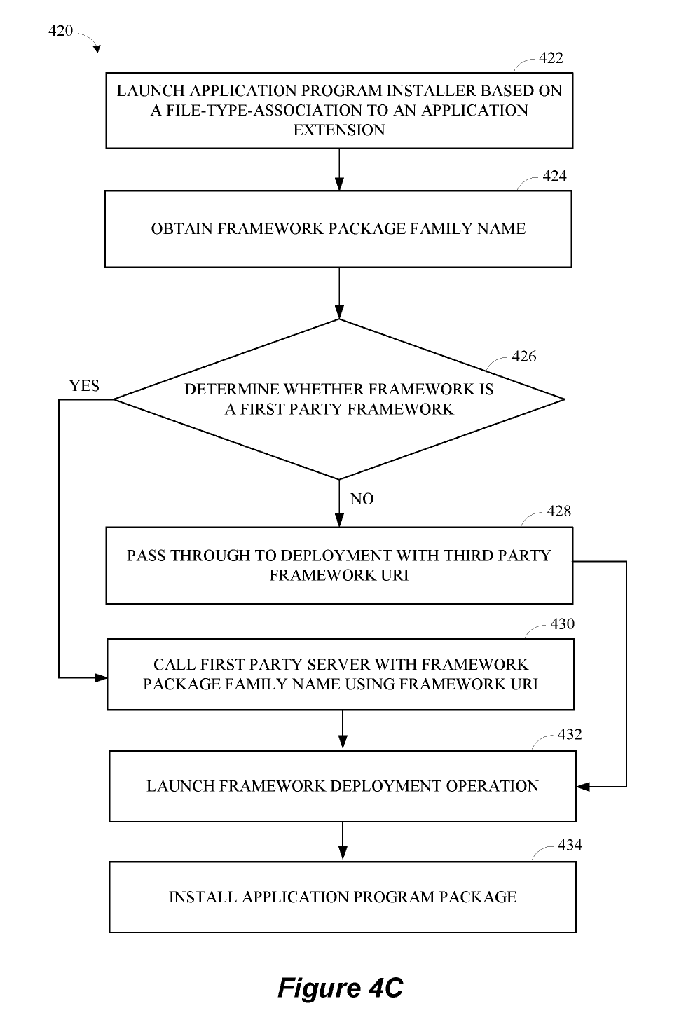

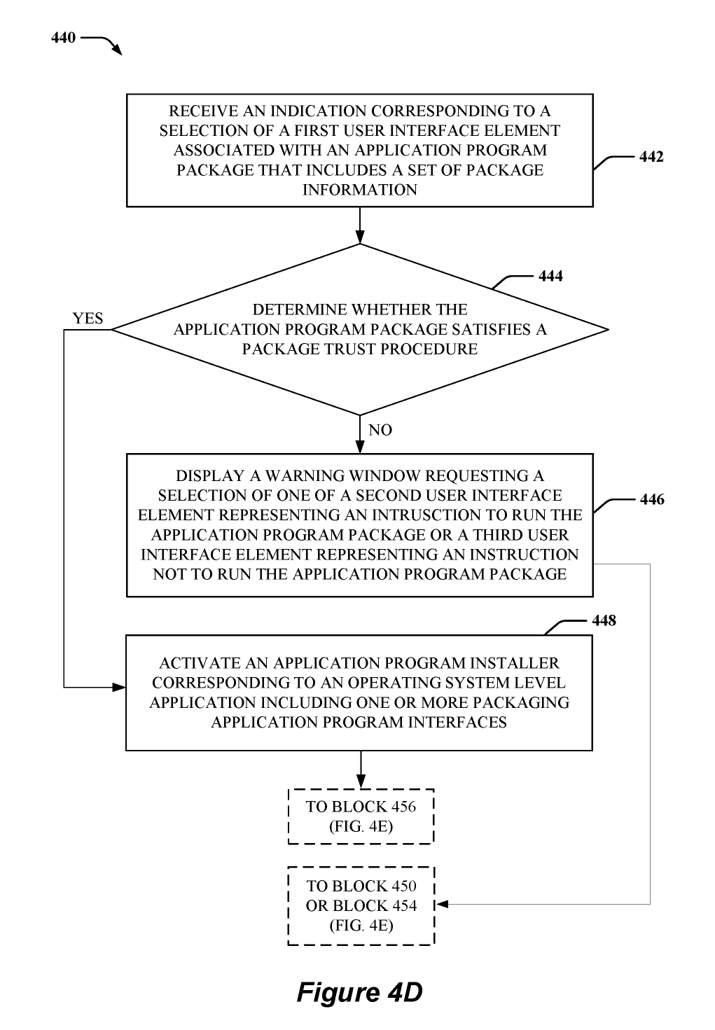

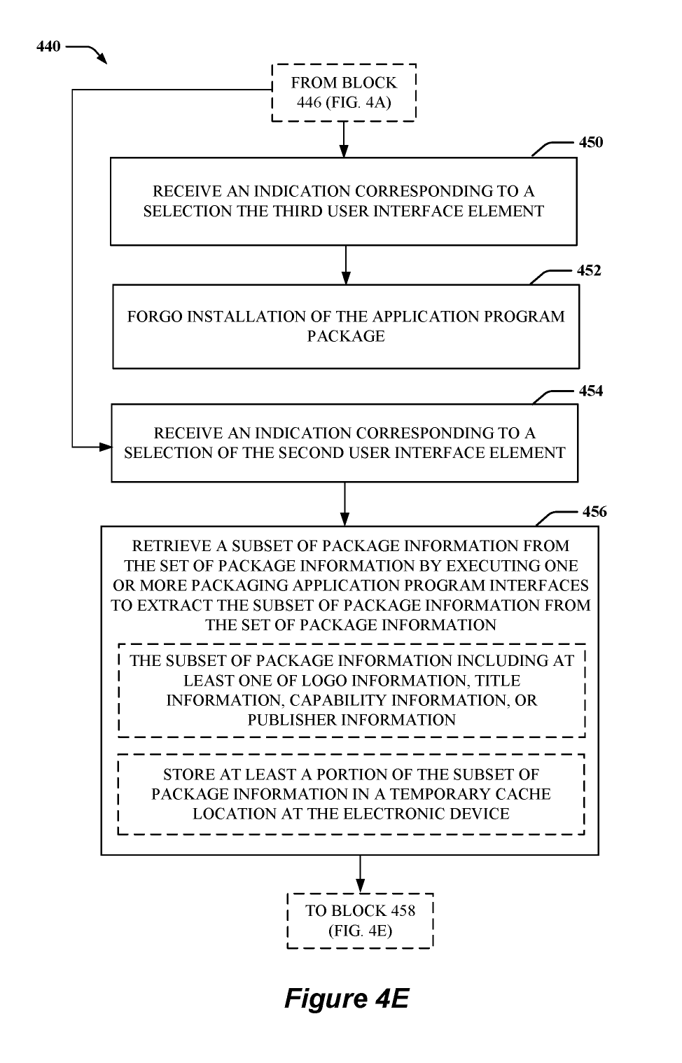

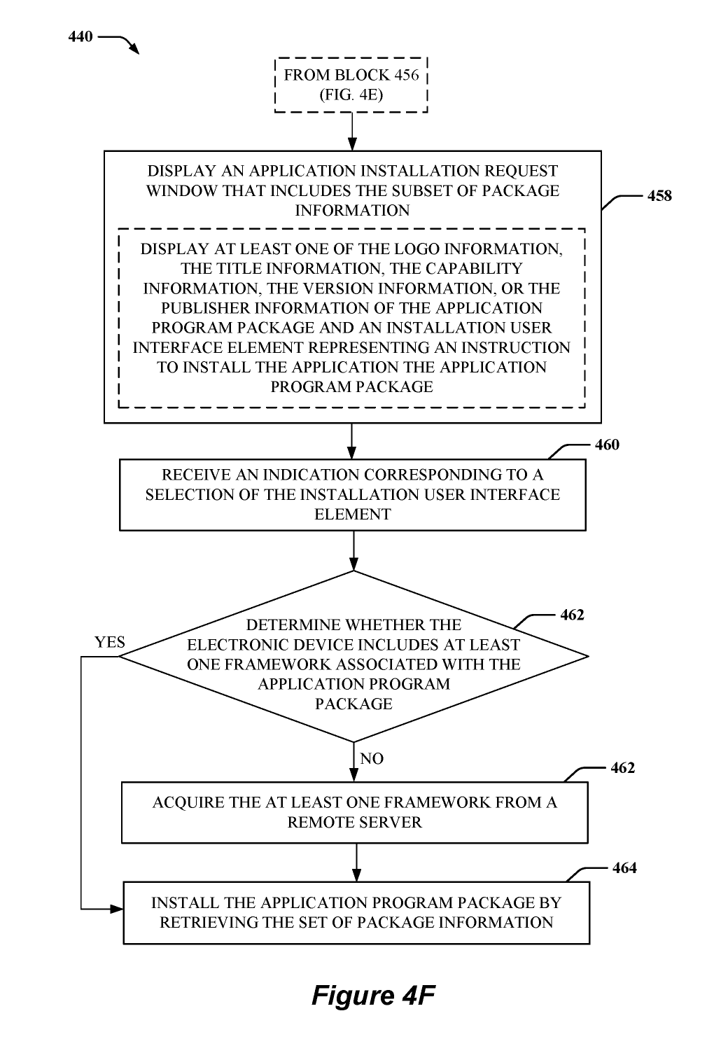

FIGS. 4A and 4B are flow diagrams of an example of a method 400 related to presenting an application program package pre-installation user interface, downloading all or relevant portions of an application program package, and, optionally, launching the downloaded application program, in accordance with various implementations of the present disclosure. Although the operations described below are presented in a particular order and/or as being performed by an example component, it should be understood that the ordering of the actions and the components performing the actions may be varied, depending on the implementation.

At block 402, the method 400 may launch an application installer from a file-type-association to an application extension. For instance, the electronic device 100 (FIG. 1A) may execute processor 104 (FIG. 1A) to launch the application program installer 110 (FIGS. 1A and 1B) based on a file-type-association to an application extension (e.g., an auxiliary, executable file such as .appx/.appxbundle, or a supplementary routine that adds capabilities to an application). A file-type-association may be an association between a stored file having an extension and a corresponding application program configured to run or execute the stored file.

At block 404, the method 400 may open a stream to the application program package. For example, the electronic device 100 (FIG. 1A) and/or processor 104 (FIG. 1A) may execute application program installer 110 (FIGS. 1A and 1B) to open a communication link, e.g., a wired or wireless communication session, to stream or otherwise download or access the application program package 164, which may be stored on a remotely-located server such as first server 130. For example, the electronic device 100 (FIG. 1A) and/or processor 104 (FIG. 1A) may execute application program installer 110 (FIGS. 1A and 1B) to open a stream, using one or more APIs, to the application program package 164 (FIGS. 1A and 1B). In some implementations, opening a stream may correspond to using at least one packaging API to read the application program package 164 (FIGS. 1A and 1B).

At block 406, the method 400 may obtain application program package metadata using the application program interfaces. For example, the electronic device 100 (FIG. 1A) and/or processor 104 (FIG. 1A) may execute application program installer 110 (FIGS. 1A and 1B) to obtain application program package 164 (FIGS. 1A and 1B) metadata (e.g., subset of package information 152, FIGS. 1B) using the APIs 166 (FIG. 1B). In some implementations, the APIs 166 may include one or more packaging APIs that may unpackage the application program package 164 (FIGS. 1A and 1B) to read and/or access at least the metadata.

At block 408, the method 400 may copy one or more resources and a logo to a local application folder. For example, the electronic device 100 (FIG. 1A) and/or processor 104 (FIG. 1A) may execute application program installer 110 (FIGS. 1A and 1B) to copy one or more resources (e.g., title 154, version 156, application capabilities 158, and/or publisher 162, FIG. 1B) and a logo 160 (FIG. 1B) to a local application folder at electronic device 100 (FIG. 1A). In some implementations, the local application folder may be a temporary folder such as a cache folder.

At block 410, the method 400 may present the user with the application program package metadata in the application installation request window. For example, the electronic device 100 (FIG. 1A) and/or processor 104 (FIG. 1A) may execute display 112 (FIG. 1A) and/or display interface 124 (FIG. 1A) to present the user with the application program package metadata (e.g., the subset of package information 152) in the application installation request window 168.

At block 412, the method 400 may begin a deployment operation in response to detecting a selection of an install user interface element. For example, the electronic device 100 (FIG. 1A) and/or processor 104 (FIG. 1A) may execute application program installer 110 (FIGS. 1A and 1B) to begin the deployment and/or installation operation using one or more APIs 166 (FIG. 1B) in response to detecting a selection of an installation election user interface element 172 (FIG. 1B) (e.g., on application installation request window 168, FIG. 1B).

At block 414, the method 400 may use deployment APIs to locate the installed application program package. For example, the electronic device 100 (FIG. 1A) and/or processor 104 (FIG. 1A) may execute the operating system 170 (FIG. 1A) to use deployment APIs to locate the installed application program package 164 (FIGS. 1A and 1B). In some implementations, the APIs 166 may include one or more deployment APIs which when executed, locate and install the application program package 164 (FIGS. 1A and 1B).

At block 416, the method 400 may optionally (as represented by the dashed line box) launch the application program. For example, the electronic device 100 (FIG. 1A) and/or processor 104 (FIG. 1A) may execute the operating system 170 (FIG. 1A) to launch the application program 156 (FIG. 1A).

FIG. 4C is a flow diagram of an example of a method 420 related to acquiring a framework during an application program package pre-install procedure in accordance with various implementations of the present disclosure. Although the operations described below are presented in a particular order and/or as being performed by an example component, it should be understood that the ordering of the actions and the components performing the actions may be varied, depending on the implementation.

At block 422, the method 420 may launch an application program installer based on a file-type-association to an application extension. For example, the electronic device 100 (FIG. 1A) and/or processor 104 (FIG. 1A) may execute operating system 170 (FIG. 1B) to launch an application program installer 110 (FIGS. 1A and 1B) from a file-type-association to an application extension (e.g., .appx).

At block 424, the method 420 may obtain a framework package family name. For example, the electronic device 100 (FIG. 1A) and/or processor 104 (FIG. 1A) may execute application program installer 110 (FIGS. 1A and 1B) to obtain a framework package family name, which may be an identifier used to locate the corresponding framework 132 (FIGS. 1A and 1B), using the extracted metadata (e.g., framework package family name included in the manifest file). In some implementations, the framework package family name may be a string identifier that is a combination of the name of the framework 132 (FIG. 1B) name, name of the publisher 162 (FIG. 1B), version 156 (FIG. 1B), and/or supported architectures (e.g., ARM, x86, x64).

At block 426, the method 420 may determine whether the framework is a first party framework. For example, the electronic device 100 (FIG. 1A) and/or processor 104 (FIG. 1A) may execute application program installer 110 (FIGS. 1A and 1B) to determine whether the framework 132 (FIGS. 1A and 1B) is a first party framework. In some implementations, the first party framework may be the framework 132 (FIGS. 1A and 1B) associated with the operating system 170 and residing at the second server 134 that is a first party server.

The method 420 may proceed to block 428 based on a determination that the framework is not a first party framework. At block 428, the method 420 may pass through to deployment with third party framework URI. For example, the electronic device 100 (FIG. 1A) and/or processor 104 (FIG. 1A) may execute application program installer 110 (FIGS. 1A and 1B) to pass through to deployment with third party framework URI. Specifically, the third party framework URI corresponding to a location of the framework 132 (FIGS. 1A and 1B) may be forwarded along to deployment at block 432.

Otherwise, the method 420 may proceed to block 430 based on a determination that the framework is a first party framework. At block 430, the method 420 may call a first party server with the framework package family name using the framework URI. For example, the electronic device 100 (FIG. 1A) and/or processor 104 (FIG. 1A) may execute application program installer 110 (FIGS. 1A and 1B) to call a first party server (e.g., second server 134, FIG. 1A) with the framework package family name using the framework URI. Specifically, using a framework acquisition API, the second server 134 (FIG. 1A) may be queried to obtain the framework URI corresponding to a location of the framework 132 (FIGS. 1A and 1B).

At block 432, the method 420 may launch a framework deployment operation. For example, the electronic device 100 (FIG. 1A) and/or processor 104 (FIG. 1A) may execute application program installer 110 (FIGS. 1A and 1B) to launch framework deployment operation corresponding to an installation of the framework 132 (FIGS. 1A and 1B).

At block 434, the method 420 may install the application program package. For example, the electronic device 100 (FIG. 1A) and/or processor 104 (FIG. 1A) may execute application program installer 110 (FIGS. 1A and 1B) to install the application program package 164 (FIGS. 1A and 1B).

FIGS. 4D-4F are flow diagrams of an example of a method 440 of an application program package installation procedure in accordance with various implementations of the present disclosure. Although the operations described below are presented in a particular order and/or as being performed by an example component, it should be understood that the ordering of the actions and the components performing the actions may be varied, depending on the implementation. For example, the method 440 may include or otherwise be combined with the method 400 (FIGS. 4A and 4B) and/or the method 420 (FIG. 4C).

At block 442, the method 440 may receive an indication corresponding to a selection of a first user interface element associated with an application program package that includes a set of package information. For example, the electronic device 100 (FIG. 1A) and/or processor 104 (FIG. 1A) may execute one or both of the display 112 (FIG. 1A) or the display interface 124 (FIG. 1A) to receive an indication corresponding to a selection of a first user interface element (e.g., application program download button on display interface 124 that is linked to and accessible via a URI to a location of application program package 164 at first server 130, FIG. 1A) associated with an application program package 164 (FIGS. 1A and 1B) that includes a set of package information (e.g., the set of package information 150, FIG. 1B). In some implementations, the first user interface element may correspond to one of: a hypertext link within a web browser window, a selectable item referencing the application program 156 (FIG. 1A) within an email message including the application program package 164 (FIGS. 1A and 1B), or an icon within a local drive window representing a location of the application program package 164 (FIGS. 1A and 1B). Further, the application program package 164 (FIGS. 1A and 1B) may correspond to an installation package having an operating system-specific structure.

At block 444, the method 440 may optionally (as represented by the dashed line decision diamond) determine whether the application program package satisfies a package trust procedure. For example, the electronic device 100 (FIG. 1A) and/or processor 104 (FIG. 1A) may execute operating system 170 to determine whether the application program package 164 (FIGS. 1A and 1B) satisfies a package trust procedure 136 (FIG. 1A). In some implementations, the package trust procedure 136 (FIG. 1A) may include determining whether the publisher 162 (FIG. 1B) associated with the application program package 164 (FIGS. 1A and 1B) may be included in a trusted publisher database.

The method 440 may proceed to block 446 in accordance with a determination that the application program package does not satisfy a package trust procedure. At block 446, the method 440 may display a warning window requesting a selection of one of a second user interface element representing an instruction to run the application program package or a third user interface element representing an instruction not to run the application program package. For example, the electronic device 100 (FIG. 1A) and/or processor 104 (FIG. 1A) may execute trust procedure 136 (FIG. 1A) to display a warning window (e.g., in display interface 124) requesting a selection of one of a second user interface element (e.g., download/continue button) representing an instruction to run the application program package 164 (FIGS. 1A and 1B) or a third user interface element (e.g., abort/cancel button) representing an instruction not to run the application program package 164 (FIGS. 1A and 1B) based on a determination that the application program package 164 (FIGS. 1A and 1B) does not satisfy the package trust procedure 136 (FIG. 1A). In some implementations, displaying the warning window includes displaying in accordance with a determination that the publisher 162 (FIG. 1B) associated with the application program package 164 (FIGS. 1A and 1B) may not be included in the trusted publisher database.

Otherwise, the method 440 may proceed to block 448 in accordance with a determination that the application program package satisfies a package trust procedure, or if block 444 is not implemented. At block 448, the method 440 may activate an application program installer corresponding to an operation system level application including one or more packaging APIs. For example, the electronic device 100 (FIG. 1A) and/or processor 104 (FIG. 1A) may execute operating system 170 to activate an application program installer 110 (FIGS. 1A and 1B) corresponding to an operation system level application including one or more packaging APIs. For example, the application program installer 110 (FIGS. 1A and 1B) may be associated with a file type of the application program package 164. In some implementations, activating the application program installer 110 (FIGS. 1A and 1B) may include launching the application program installer 110 (FIGS. 1A and 1B) in response to at least one of receiving the indication corresponding to a selection of the first user interface element (e.g., application program download button) or a selection of the second user interface element (e.g., download/continue button), the application program installer 110 (FIGS. 1A and 1B) at least retrieves the subset of package information 152 (FIG. 1B) from the set of package information 150 (FIG. 1B) for display of the subset of package information 152 (FIG. 1B) within the application installation request window 168 (FIG. 1B). Further, the application program installer 110 (FIGS. 1A and 1B) may be associated with a file type of the application program package 164 (FIGS. 1A and 1B).

At block 450, the method 440 may receive an indication corresponding to a selection of the third user interface element (e.g., abort/cancel button). For example, the electronic device 100 (FIG. 1A) and/or processor 104 (FIG. 1A) may execute display interface 124 (FIG. 1A) or at least one input device to receive an indication corresponding to a selection of the third user interface element.

At block 452, the method 440 may forgo installation of the application program package in response to the indication corresponding to the selection of the third user interface element. For example, the electronic device 100 (FIG. 1A) and/or processor 104 (FIG. 1A) may execute the application program installer 110 (FIGS. 1A and 1B) to forgo installation of the application program package 164 (FIGS. 1A and 1B) in response to the indication corresponding to the selection of the third user interface element. In other words, upon selection, the third user interface element (e.g., abort/cancel button) may abort or cancel a download and/or installation of the application program package 164 (FIGS. 1A and 1B).

At block 454, the method 440 may receive an indication corresponding to a selection of the second user interface element. For example, the electronic device 100 (FIG. 1A) and/or processor 104 (FIG. 1A) may execute display interface 124 (FIG. 1A) to receive an indication corresponding to a selection of the second user interface element (e.g., download/continue button). That is, the user was presented a warning window that a publisher of the application program package 164 (FIGS. 1A and 1B) was not recognized, yet elected to continue with the download and installation process nonetheless upon selecting the second user interface element.

Further, at block 456, the method 440 may retrieve a subset of package information from the set of package information by executing one or more packaging APIs to extract the subset of package information from the set of package information. For example, the electronic device 100 (FIG. 1A) and/or processor 104 (FIG. 1A) may execute the application program installer 110 (FIGS. 1A and 1B) to retrieve a subset of package information 152 (FIG. 1B) from the set of package information 150 (FIG. 1B) by executing one or more packaging APIs 166 (FIG. 1B) to extract the subset of package information 152 (FIG. 1B) from the set of package information 150 (FIG. 1B).

In some implementations, the subset of package information 152 (FIG. 1B) may include at least one of logo information 160 (FIG. 1B), title information 154 (FIG. 1B), application capability information 158 (FIG. 1B), or publisher information 162 (FIG. 1B). Further, retrieving the subset of package information 152 from the set of package information 150 at block 456 may include storing at least a portion of the subset of package information 152 (FIG. 1B) in a temporary cache location (e.g., memory 106, FIG. 1A) at the electronic device 100 (FIG. 1A). Moreover, in some implementations, the subset of package information 152 (FIG. 1B) may be extracted from the set of package information 150 (FIG. 1B) based on at least on a manifest file associated with the application program package 164 (FIGS. 1A and 1B). Additionally, retrieving the subset of package information 152 (FIG. 1B) from the set of package information 150 (FIG. 1A) may include retrieving the subset of package information 152 (FIG. 1B) in response to receiving the indication corresponding to a selection of the second user interface element (e.g., download/continue button) at block 454. Further, the subset of package information 152 (FIG. 1B) may further include a version information 156 (FIG. 1B) of the application program package 164 (FIGS. 1A and 1B).

At block 458, the method 440 may display an application installation request window that includes the subset of package information. For example, the electronic device 100 (FIG. 1A) and/or processor 104 (FIG. 1A) may execute the display 112 (FIG. 1A) to display an application installation request window 168 (FIG. 1B) including the subset of package information 152 (FIG. 1B).

In some implementations, displaying the application installation request window 168 (FIG. 1B) including the subset of package information 152 (FIG. 1B) may include displaying at least one of the logo information 160 (FIG. 1B), title information 154 (FIG. 1B), application capability information 158 (FIG. 1B), or publisher information 162 (FIG. 1B) of the application program package 164 (FIGS. 1A and 1B) and an installation interface element (e.g., install 202 button/affordance, FIG. 2A) representing an instruction to install the application program package 164. Further, the application installation request window 168 (FIG. 1B) may be displayed in accordance with a determination that the application program package 164 (FIGS. 1A and 1B) satisfies the package trust procedure 136 (FIG. 1A) at block 444.

At block 460, the method 440 may receive an indication corresponding to a selection of the installation user interface element. For example, the electronic device 100 (FIG. 1A) and/or processor 104 (FIG. 1A) may execute display interface 124 or at least one input device to receive an indication corresponding to a selection of the installation user interface element.

At block 462, optionally, the method 440 may determine whether the electronic device includes at least one framework associated with the application program package. For example, the electronic device 100 (FIG. 1A) and/or processor 104 (FIG. 1A) may execute the application program installer 110 (FIGS. 1A and 1B) to determine whether the electronic device 100 (FIG. 1A) includes at least one framework 132 (FIGS. 1A and 1B) associated with the application program package 164 (FIGS. 1A and 1B). For instance, to determine whether the electronic device 100 (FIG. 1A) includes at least one framework 132 (FIGS. 1A and 1B) associated with the application program package 164 (FIGS. 1A and 1B), the method 440 may include or otherwise perform any one or more blocks from the method 420 (FIG. 4C).

The method 440 may proceed to block 464 in accordance with a determination that the electronic device does not include at least one framework associated with the application program package. At block 464, the method 440 may acquire the at least one framework from a remote server. For example, the electronic device 100 (FIG. 1A) and/or processor 104 (FIG. 1A) may execute the application program installer 110 (FIGS. 1A and 1B) to acquire the at least one framework 132 (FIGS. 1A and 1B) from a remote server (e.g., second server 134, FIG. 1A).

Otherwise, the method 440 may proceed to block 466 in accordance with a determination that the electronic device includes at least one framework associated with the application program package, or if the determination of block 462 is not performed (e.g., if the application program package 164 does not require a framework). At block 466, the method 440 may install the application program package by retrieving the set of package information. For example, the electronic device 100 (FIG. 1A) and/or processor 104 (FIG. 1A) may execute the application program installer 110 (FIGS. 1A and 1B) to install the application program package 164 (FIGS. 1A and 1B) by retrieving the set of package information 150 (FIG. 1B). In some implementations, installing the application program package 164 (FIGS. 1A and 1B) may include installing the application program package 164 (FIGS. 1A and 1B) by retrieving the set of package information 150 (FIG. 1B), or some subset thereof, such as a language-specific subset, in accordance with a determination that the electronic device includes at least one framework 132 (FIG. 1B) associated with the application program package and/or in response to acquiring the at least one framework 132 (FIG. 1B) from the remote server (e.g., second server 134, FIG. 1B).

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various implementations are described herein in connection with a device (e.g., electronic device 100 and/or computer device 500), which can be a wired device or a wireless device. A wireless device may be a wearable electronic device, a cellular telephone, a satellite phone, a cordless telephone, a Session Initiation Protocol (SIP) phone, a wireless local loop (WLL) station, a personal digital assistant (PDA), a handheld device having wireless connection capability, a computer device, or other processing devices connected to a wireless modem.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features will be presented in terms of systems that may include a number of devices, components, modules, and the like. It is to be understood and appreciated that the various systems may include additional devices, components, modules, etc., and/or may not include all of the devices, components, modules, etc., discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or algorithm may reside as one or any combination or set of codes and/or instructions on a machine readable medium and/or computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with implementations disclosed herein.

What is claimed is:

1. A method of presenting application program information on a display of an electronic device, comprising:
receiving an indication corresponding to a selection of a first user interface element associated with an application program package that includes a set of package information;
retrieving a subset of package information from the set of package information by executing one or more packaging application program interfaces (APIs) to extract the subset of package information from the set of package information; and
displaying, within a user interface of the display, an application installation request window that includes the subset of package information.

2. The method of claim 1, wherein the subset of package information including at least one of logo information, title information, capability information, or publisher information, and wherein retrieving the subset of package information from the set of package information includes:
storing at least a portion of the subset of package information in a temporary cache location at the electronic device.

3. The method of claim 2, wherein the subset of package information is extracted from the set of package information based on at least on a manifest file associated with the application program package.

4. The method of claim 2, wherein displaying the application installation request window includes displaying at least one of the logo information, the title information, the capability information, or the publisher information of the application program package and further displaying an installation user interface element representing an instruction to install the application program package.

5. The method of claim 4, further comprising:
receiving an indication corresponding to a selection of the installation user interface element; and
installing the application program package by retrieving the set of package information in response to receiving the indication corresponding to a selection of the installation user interface element.

6. The method of claim 5, further comprising:
determining whether the electronic device includes at least one framework associated with the application program package;
acquiring the at least one framework from a remote server in accordance with a determination that the electronic device does not include at least one framework associated with the application program package,
wherein installing the application program package includes installing the application program package by retrieving the set of package information in accordance with a determination that the electronic device includes at least one framework associated with the application program package or in response to acquiring the at least one framework from the remote server.

7. The method of claim 1, further comprising:
determining whether the application program package satisfies a package trust procedure in response to receiving the indication corresponding to the selection of the first user interface element;
displaying, within the user interface, a warning window requesting a selection of one of a second user interface element representing an instruction to run the application program package or a third user interface element representing an instruction not to run the application program package in accordance with a determination that the application program package does not satisfy the package trust procedure, and
receiving an indication corresponding to a selection of at least one of the second user interface element or the third user interface element.

8. The method of claim 7, wherein retrieving the subset of package information from the set of package information includes retrieving the subset of package information in response to receiving the indication corresponding to a selection of the second user interface element,
wherein the application installation request window is displayed in accordance with a determination that the application program package satisfies the package trust procedure.

9. The method of claim 7, wherein the package trust procedure includes determining whether a publisher associated with the application program package is included in a trusted publisher database,
wherein displaying the warning window includes displaying in accordance with a determination that the publisher associated with the application program package is not included in the trusted publisher database.

10. The method of claim 7, further comprising launching an application program installer in response to at least one of receiving the indication corresponding to a selection of the first user interface element or a selection of the second user interface element, the application program installer at least retrieves the subset of package information from the set of package information for display of the subset of package information within the application installation request window,
wherein the application program installer is associated with a file type of the application program package.

11. The method of claim 1, wherein the subset of package information includes version information of the application program package.

12. The method of claim 1, wherein the first user interface element corresponds to one of:
a hypertext link within a web browser window;
a selectable item referencing the application program within an email message including the application program package; or
an icon within a local drive window representing a location of the application program package.

13. The method of claim 1, wherein the application program package corresponds to an installation package having an operating system-specific structure.

14. The method of claim 1, wherein the electronic device is one of a personal computing device or a mobile device.

15. An electronic device for presenting application program information, comprising:
a memory configured to store data and instructions;
a display configured to present information; and
a processor in communication with the memory and the display, wherein the processor is configured to:
receive an indication corresponding to a selection of a first user interface element associated with an application program package that includes a set of package information;
retrieve a subset of package information from the set of package information by executing one or more packaging application program interfaces (APIs) to extract the subset of package information from the set of package information; and
display, within a user interface of the display, an application installation request window that includes the subset of package information.

16. The electronic device of claim 15, wherein the subset of package information including at least one of logo information, title information, capability information, or publisher information, and wherein to retrieve the subset of package information from the set of package information, wherein the processor is further configured to:
store at least a portion of the subset of package information in a temporary cache location at the electronic device.

17. The electronic device of claim 16, wherein the subset of package information is extracted from the set of package information based on at least on a manifest file associated with the application program package.

18. The electronic device of claim 16, wherein to display the application installation request window, the processor is further configured to display at least one of the logo information, the title information, the capability information, or the publisher information of the application program package and an installation user interface element representing an instruction to install the application program package.

19. The electronic device of claim 18, wherein the processor is further configured to:
receive an indication corresponding to a selection of the installation user interface element; and
install the application program package by retrieving the set of package information in response to receiving the indication corresponding to a selection of the installation user interface element.

20. A computer-readable medium storing instructions executable by an electronic device for presenting application program information, comprising at least one instruction for causing the electronic device to:
receive an indication corresponding to a selection of a first user interface element associated with an application program package that includes a set of package information;
retrieve a subset of package information from the set of package information by executing one or more packaging application program interfaces (APIs) to extract the subset of package information from the set of package information; and
display, within a user interface of a display, an application installation request window that includes the subset of package information.
